(19) United States
(12) Patent Application Publication
(10) Pub. No.: US 2026/0178056 A1
(43) Pub. Date: Jun. 25, 2026

(54) VISION-LANGUAGE LARGE MODEL-BASED MULTI-ROBOT COLLABORATIVE NAVIGATION METHOD AND SYSTEM

(71) Applicant: TONGJI UNIVERSITY, Shanghai (CN)

(72) Inventors: Bin He, Shanghai (CN); Zhipeng Wang, Shanghai (CN); Mingming Sun, Shanghai (CN); Yanmin Zhou, Shanghai (CN); Shuo Jiang, Shanghai (CN); Bin Cheng, Shanghai (CN)

(73) Assignee: TONGJI UNIVERSITY, Shanghai (CN)

(21) Appl. No.: 19/394,735

(22) Filed: Nov. 19, 2025

(30) Foreign Application Priority Data
Dec. 25, 2024 (CN) 202411927576.2

(51) Int. Cl. G05D 1/69; G05D 1/246; G05D 1/622; G05D 1/644; G05D 1/648; G05D 101/15; G05D 109/10; G05D 111/10; G06T 7/50

(52) U.S. Cl. CPC G05D 1/69; G05D 1/2467; G05D 1/622; G05D 1/644; G05D 1/648; G06T 7/50; G05D 2101/15; G05D 2109/10; G05D 2111/10; G06T 2207/10028; G06T 2207/20081; G06T 2207/20084

(57) ABSTRACT

The present invention relates to a vision-language large model-based multi-robot collaborative navigation method and system. The method includes steps of: according to a task instruction input by a user, combined with a semantic map constructed by each robot, allocating subtask instructions to robots after parsing by a large language model; acquiring, by each robot, an environmental image in real time, according to the allocated subtask instruction, parsing and predicting a next action using a vision-language navigation large model, and executing a corresponding action and updating a state by the robot; and monitoring a robot state and checking task progress in real time through a human-machine interface and adjusting a task or handling an exception during execution when needed by an operator, and dynamically adjusting, by the robot, an execution strategy according to feedback information to optimize navigation for task completion.

### CROSS-REFERENCE TO RELATED APPLICATION

This application claims priority benefit of Chinese application serial no. 202411927576.2, filed on Dec. 25, 2024. The entirety of the above-mentioned patent application is hereby incorporated by reference herein and made a part of this specification.

### TECHNICAL FIELD

The present invention relates to the technical field of multi-robot collaborative navigation, and in particular to a vision-language large model-based multi-robot collaborative navigation method and system.

### BACKGROUND

With the rapid development of artificial intelligence and robot technology, multi-robot systems have gained extensive attention and applications in many fields, such as intelligent manufacturing, intelligent warehousing, indoor cleaning, logistics distribution, and post-disaster rescue. Multi-robot collaborative work can complete tasks that are difficult for a single robot to accomplish independently, significantly improving task execution efficiency and system adaptability. At the same time, it also faces challenges in achieving efficient collaboration, task allocation, and navigation planning among robots in complex and dynamic environments.

Traditional multi-robot collaborative navigation and task allocation methods mostly rely on predefined rules, static maps, and limited sensor information. These methods are typically limited to fixed task scenarios and lack real-time response capabilities to dynamic environments, resulting in poor flexibility and adaptability of the system when facing task changes or environmental variations. Meanwhile, existing multi-robot systems typically rely on simple sensor data (such as lidar, ultrasonic sensors, etc.) and hard-coded task allocation strategies. They have limited ability to understand complex or unknown environments and lack the capability of intelligent parsing and flexible execution of complex task instructions. Especially in complex task scenarios, how to understand and execute natural language instructions from operators, and how to dynamically adjust and allocate subtasks according to the capabilities and states of different robots as well as environmental changes are key difficulties in current multi-robot collaborative systems.

Although significant progress has been made in deep learning and natural language processing technologies in recent years, research on integrating natural language with visual information to form efficient and intelligent vision-language large models and applying them to multi-robot collaborative navigation and task allocation is still in its infancy. Most existing systems can only process simple fixed instructions when parsing task instructions, making it difficult to cope with complex and variable instruction requirements put forward by users in dynamic environments, failing to give full play to their advantages in multimodal information fusion.

To solve these problems, in recent years, some studies have attempted to introduce vision-language models and human-machine interaction mechanisms to enhance the intelligence level and flexibility of robot systems. By combining visual information and natural language understanding, robots can more accurately understand the operator's intentions, and conduct task adjustment and path planning in real time. However, the current technology still has the following deficiencies: on the one hand, the application of existing vision-language models in multi-robot collaborative tasks is not yet mature, making it difficult to perform real-time and effective task allocation and collaboration in complex task environments; on the other hand, the interaction between robots and operators is still relatively limited, which cannot efficiently support dynamic task allocation and real-time feedback.

Therefore, there is an urgent need for a new method that integrates a vision-language large model and a human-machine interaction mechanism to improve the cooperative efficiency and task execution flexibility of multi-robot systems in a complex dynamic environment.

### SUMMARY

An objective of the present invention is to overcome the defects of the above prior art and provide a vision-language large model-based multi-robot collaborative navigation method and system.

The objective of the present invention can be achieved through the following technical solutions:

As a first aspect of the present invention, a vision-language large model-based multi-robot collaborative navigation method is provided, including steps of:
according to a task instruction input by a user, combined with a semantic map constructed by each robot, allocating subtask instructions to robots after parsing by a large language model;
collecting, by each robot, an environmental image in real time and mapping it into a visual embedding using a visual perception module, while mapping the allocated subtask language instruction into a language embedding;
performing cross-modal feature alignment on the visual embedding and the language embedding to obtain a vision-language multimodal fusion feature, inputting it into a vision-language navigation large model dedicated to each robot for parsing, predicting and generating a navigation action of each robot, and executing, by the robot, the navigation action;
monitoring task progress and an environmental change in real time, and if a new task or an environmental change is detected, performing, by an operator, task adjustment and exception handling; and if the task instruction changes, dynamically adjusting an execution strategy according to feedback information from the operator and updating a state by the robot; and
repeating the above steps until each robot successfully completes the allocated subtask and reaches a target position.

As a preferred technical solution, steps for constructing the semantic map by each robot are specifically as follows:
at an initial state moment, the robot rotating and collecting an RGB image and a depth map in real time through a camera every 30 degrees;
for the RGB image, extracting an RGB feature from the RGB image through a pre-trained ResNet50-based visual feature extraction network, for the depth map, extracting a depth feature from the depth map through point cloud generation, and jointly modeling the RGB feature and the depth feature through point cloud projection to form an RGB-D joint feature;
based on the RGB-D joint feature, performing layer-by-layer upsampling on the RGB-D joint feature using a decoder of a pre-trained semantic segmentation network, classifying each pixel of the RGB-D joint feature, and generating a semantic segmentation map;
performing three-dimensional point cloud conversion on a pixel-classified label map and depth map, fusing semantic point clouds from a plurality of frames, and mapping to generate a three-dimensional scene model with a semantic label; and
projecting the three-dimensional scene model with the semantic label onto a two-dimensional grid map through two-dimensional grid projection processing to obtain the semantic map.

As a preferred technical solution, steps for allocating the subtask instructions to the most suitable robots after parsing the task instruction input by the user through the large language model are specifically as follows:
adopting a large language model GPT3.5 to replace a scene prior, merging scattered semantic maps according to positions of the robots to obtain a pieced semantic map, which includes information on a robot position, a scene structure, a scene object, and a target category, and formatting them into prompts in a fixed format; and
based on the prompts and a current state of each robot, decomposing an overall task into the most suitable subtasks for each robot, with the large language model GPT3.5 acting as a global planner according to the task instruction input by the user.

As a preferred technical solution, mapping, by the robot, the environmental image collected in real time into the visual embedding using the visual perception module includes:
extracting an RGB visual embedding using visual encoders with DINOv2 and SigLIP pre-trained features; and
extracting a depth visual embedding using an InceptionNet network; and
mapping the allocated subtask language instruction into the language embedding is specifically as follows: converting the task instruction into a corresponding global vector word embedding, and extracting the language embedding using a pre-trained BERT language model.

As a preferred technical solution, steps for constructing the vision-language multimodal fusion feature are as follows: performing cross-modal feature alignment on the RGB visual embedding and the depth visual embedding in the visual embedding with the language embedding, respectively, using a cross-attention mechanism to obtain an RGB-language multimodal feature E_{RGB-L} and a depth-language multimodal featureE_{RGB-L}; and concatenating the RGB-language multimodal feature and the depth-language multimodal feature and inputting them into a Llama2 large language model to predict a next navigation action of the robot.

As a preferred technical solution, the vision-language navigation large model is based on a Llama2 large language model and adopts joint training of a plurality of modalities, with a training process specifically as follows:
inputting historical video information and current frame video information of a robot navigation video as well as a subtask natural language instruction into the Llama2 large language model;
based on processing of the robot navigation video by an image encoder, identifying different information using special tokens to distinguish which modality a current input token sequence comes from;
feeding collected robot vision-language navigation data into a robot vision-language navigation large model for training: discretizing a continuous measurement range of robot navigation actions into multi-dimensional action tokens, respectively, and covering tokens used in a Llama vocabulary; and training the vision-language large model using a standard next-token prediction target, and evaluating cross-entropy loss on a predicted action token; and
collecting robot vision-language navigation trajectories according to different task scenarios, and fine-tuning the robot vision-language navigation large model using LoRA.

As a preferred technical solution, the vision-language navigation data is collected in a Habitat simulator, specifically as follows:
performing semantic segmentation in the Habitat simulation simulator, finding the shortest path from a starting point to a target point using a path planning algorithm, and performing natural language labeling on a navigation trajectory using GPT3.5 according to semantic information on a path to obtain a video-language data pair; and
given an instruction, collecting an image sequence in a navigation trajectory corresponding to this instruction and outputting a corresponding next action; or given an image of a trajectory, outputting a corresponding instruction.

As a preferred technical solution, the monitoring task progress and an environmental change in real time, and if a new task or an environmental change is detected, performing, by an operator, task adjustment and exception handling are specifically as follows:
detecting, by the robot, a current state and environmental information, and transmitting current observation to an upper computer, where the upper computer displays observation data and current task execution progress of each robot in real time;
when an abnormal situation including a new obstacle in an environment, a change in a target position, a delay, a failure, or a sudden task requirement is detected, issuing a warning prompt and feeding back environmental change information and a task abnormal situation to the operator, intervening, by the operator, through inputting a new instruction or adjusting an existing task plan, and synchronizing a modification of the operator to a robot system in real time; and
receiving, by the robot vision-language navigation large model, feedback information of the operator, parsing it through the large language model and generating a new task strategy, adjusting, by the robot, execution logic according to the new task strategy, and updating its own state in real time during execution of an adjusted task; and synchronously updating, by the system, task states and semantic maps of all robots.

As a second aspect of the present invention, a vision-language large model-based multi-robot collaborative navigation system adopting the above vision-language large model-based multi-robot collaborative navigation method is provided, including:
a multi-robot task allocation module configured to parse a high-level task instruction input by a user based on vision-language multimodal representation information, analyze the task instruction through a large language model and decompose it into a plurality of subtasks, and allocate subtask instructions to the most suitable robots;
a visual perception and semantic understanding module configured to perform visual perception and semantic understanding on multimodal input data based on environmental information collected by a robot, including an RGBD visual image and a natural language instruction corresponding to a subtask, and extract key feature information;
a multimodal information fusion module configured to perform fusion and alignment based on a visual feature and a language feature, generate a unified multimodal representation, and perform unified encoding and representation of input heterogeneous data;
a robot vision-language navigation module configured to perform parsing based on fused vision-language multimodal representation information through a dedicated robot vision-language navigation large model of each robot, and predict and generate a navigation action of each robot, with the robot executing the action and updating a state;
a dynamic feedback and real-time optimization module configured to monitor a robot state and task progress in real time based on a state of each robot, and when a new task or an environmental change is detected, prompt the operator to perform task adjustment and exception handling, with the robot dynamically adjusting an execution strategy according to feedback information from the operator and updating the state; and
a real-robot deployment verification module configured to verify and optimize performance of a multi-robot system in an actual working environment based on a developed multi-robot collaborative navigation method.

As a preferred technical solution, the visual perception and semantic understanding module includes:
a visual feature extraction unit configured to extract an RGB visual feature through DINOv2 and SigLIP and extract a depth visual feature through an InceptionNet network based on the RGBD visual image collected by the robot for subsequent navigation and task decision-making; and
a language embedding generation unit configured to perform semantic parsing and representation of the task instruction using a pre-trained language model BERT based on the task instruction input by the user and the subtask instruction parsed and decomposed by GPT3.5, and generate language embedding information with high semantic consistency capable of being recognized by the model.

### BRIEF DESCRIPTION OF THE DRAWINGS

FIG. 1 is a schematic flow chart of a vision-language large model-based multi-robot collaborative navigation method provided by an embodiment of the present invention;

FIG. 2 is a schematic flow chart of another vision-language large model-based multi-robot collaborative navigation method provided by an embodiment of the present invention;

FIG. 3 is a schematic diagram of a vision-language large model-based multi-robot collaborative navigation system provided by an embodiment of the present invention; and

FIG. 4 is a schematic diagram of another vision-language large model-based multi-robot collaborative navigation system provided by an embodiment of the present invention;

In the accompanying drawings: 10 denotes a multi-robot task allocation module, 20 denotes a visual perception and semantic understanding module, 21 denotes a visual feature extraction unit, 22 denotes a language embedding generation unit, 30 denotes a multimodal information fusion module, 40 denotes a robot vision-language navigation module, 50 denotes a dynamic feedback and real-time optimization module, and 60 denotes a real-robot deployment verification module.

### DETAILED DESCRIPTION OF THE EMBODIMENTS

The present invention will be described in detail below with reference to the accompanying drawings and specific embodiments. This embodiment is implemented on the premise of the technical solutions of the present invention, and provides detailed implementations and specific operation processes, but the scope of protection of the present invention is not limited to the following embodiments.

### Embodiment 1

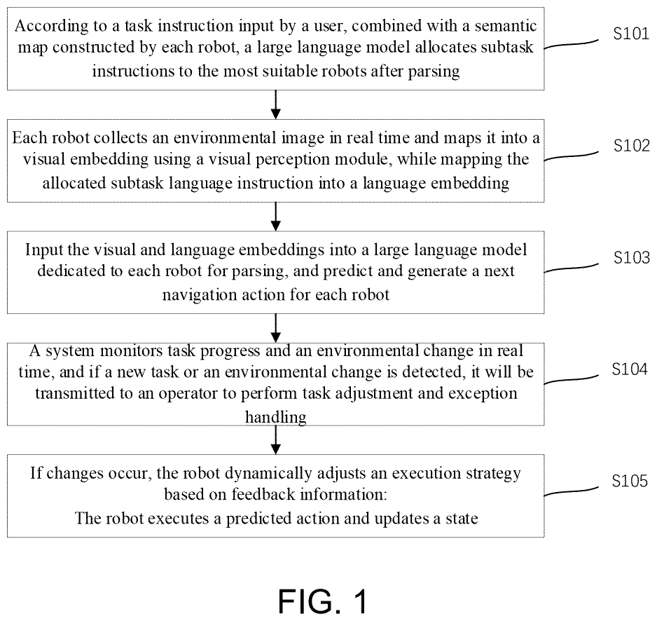

This embodiment relates to a method for multi-robot task allocation and collaborative navigation based on a vision-language large model, which is applied to a multi-robot collaborative navigation task with dynamic task allocation. As shown in FIG. 1, the method specifically includes the following steps:

Step S101. According to a task instruction input by a user, combined with a semantic map constructed by each robot, a large language model allocates subtask instructions to the most suitable robots after parsing.

The task instruction input by the user is a piece of natural language instruction, which requires semantic understanding and instruction conversion through a natural language processing module. Specifically, the user can input the task instruction in the form of text or voice through a human-machine interface, and what is finally input to the model is a piece of natural language instruction, such as “Transport item A from position X to position Y.”

The semantic map constructed by the robot refers to the semantic map generated after the robot rotates 360° at an initial moment, and an RGBD visual image captured by a camera undergoes feature extraction, SegNet network semantic segmentation, three-dimensional point cloud conversion, and two-dimensional grid projection processing.

In the embodiment of the present invention, at an initial state moment, the robot rotates 3600 and collects an RGB image and a depth map in real time through a camera every 30 degrees. The RGB image includes color information of a scene, and the depth map provides distance information from each pixel to the camera. For the RGB image, an RGB feature is extracted through a pre-trained ResNet50 visual feature extraction network; for the depth image, a depth feature is extracted through point cloud generation, and RGB and depth information are jointly modeled via point cloud projection to form a more robust feature representation. Based on these RGB-D joint features, a pre-trained SegNet semantic segmentation network is used to classify each pixel in an image, generating a semantic segmentation map. These processes can be expressed as:

$${F}_{RGB} = ResNet 50 ( RGB ) , {F}_{Depth} = PointNet ( Depth ) \qquad ( 1 )$$

where RGB and Depth represent the RGB image and the depth map collected by the robot, respectively, an RGB image feature F_{RGB} can be extracted from the RGB image through the ResNet50 network, and a depth map feature F_{Dept}h can be extracted from the depth map through a PointNet network.

$${F}_{fusion} = [ {F}_{RGB} , {F}_{Depth} ] \qquad ( 2 )$$

where [ ]represents concat feature concatenation, and by concatenating the RGB image feature F_{RGB} and the depth map feature F_{Depth}, an RGB-D joint feature F_{fusion} can be obtained.

$$S ( x , y ) = {SegNet}_{decoder} ( {F}_{fusion} ( x , y ) ) \qquad ( 3 )$$

where (x, y) represents an image pixel, and by using the decoder of the SegNet semantic segmentation network to upsample the RGB-D joint feature F_{fusion} layer by layer, a category label S(x, y) of each pixel (x, y) can be obtained.

Through a label map obtained after pixel classification and the depth map, semantic point clouds from a plurality of frames are fused and mapped to generate a three-dimensional scene model with a semantic label, which is then projected onto a two-dimensional grid map to obtain the required semantic map.

The fact that the large language model parses the task instruction input by the user and then allocates the subtask instructions to the most suitable robots means that, combined with the semantic map constructed by each robot, a GPT3.5 large language model with global information can allocate the most suitable subtask instructions to robots according to a position state of each robot.

In the embodiment of the present invention, considering that learning-based robot vision-language navigation methods usually require a large amount of computing resources to learn and utilize environmental priors, while large language models themselves contain rich knowledge about the world, the large language model GPT3.5 is selected to replace scene priors. According to positions of the robots, scattered semantic maps are merged to form a complete pieced semantic map, which includes information such as a robot position, a scene structure, a scene object, and a target category, and the information is formatted into prompts in a fixed format. Based on these prompts and a current state of each robot (a battery level, a task load, etc.), the large language model acts as a global planner according to the task instruction input by the user, decomposing the overall task into the most suitable subtasks for each robot, such as “Robot 1 is responsible for transporting item A to a transfer position” and “Robot 2 is responsible for transporting from the transfer position to an exit.”

Step S102. Each robot collects an environmental image in real time and maps it into a visual embedding using a visual perception module, while mapping the allocated subtask language instruction into a language embedding.

Collecting the environmental image in real time and mapping it into the visual embedding using the visual perception module refers to: inputting the RGB visual image collected by the robot into visual encoders with DINOv2 and SigLIP pre-trained features to extract an RGB visual embedding, and inputting the depth image into an InceptionNet network to extract a depth visual embedding. Mapping the allocated subtask language instruction into the language embedding refers to extracting the language embedding after semantic understanding of the instructions through a BERT pre-trained natural language processing module.

In the embodiment of the present invention, based on the RGBD visual image collected by the robot and the allocated subtask instruction, an image encoder and a text encoder are used, respectively, to extract a corresponding image signal and text signal into a token.

Specifically, in a robot vision-language navigation task, the model needs to use historical information to understand which part of the instruction it has completed. For a current frame, it is necessary not only to provide the latest scene information of its location but also to predict a next reasonable action that conforms to the instruction. Significant difference in roles of such image signals requires us to encode historical video information and current frame video information, respectively. Regarding image encoding, the visual encoders with DINOv2 and SigLIP pre-trained features are used to extract the RGB visual embedding, where fusion of low-level spatial information from DINOv2 and high-level semantics from SigLIP can help achieve visual generalization; and the InceptionNet network is used to extract the depth visual embedding. Regarding text encoding, the BERT pre-trained language model is used to extract the language embedding. These processes can be expressed as:

$${E}_{RGB} = [ DINOv 2 ( RGB ) , SigLIP ( RGB ) ] \qquad ( 4 )$$

where the visual encoders with DINOv2 and SigLIP pre-trained features are used, respectively, to extract the RGB visual embedding, and [ ]represents the concat feature concatenation, through which an RGB visual embedding E_{RGB} can be obtained.

$${E}_{Depth} = InceptionNet ( Depth ) \qquad ( 5 )$$

where the InceptionNet network is used to extract a depth visual embedding E_{Depth}.

$${E}_{L} = BERT ( {w}_{1} , … , {w}_{T} ) \qquad ( 6 )$$

where the task instruction is first converted into a corresponding GLoVE embedding (Global Vectors for Word Representation) and encoded into (w₁, . . . , w_{T}), with T representing a length of the instruction; then the BERT language model is used to extract a language embedding E_{L}.

Step S103. Input the visual and language embeddings into a large language model dedicated to each robot for parsing, predict and generate a navigation action for each robot, and the robot executes the action.

A multimodal feature obtained by concatenating the visual embedding and language embedding after alignment via a Transformer-based cross-attention mechanism is input into a robot vision-language navigation large model using a Llama2 large language model, which can generate a next navigation action of the robot, such as moving forward or turning.

The robot visual embedding is mapped via a multilayer perceptron network into the same format as the language embedding. The vision-language multimodal data first undergo cross-modal feature alignment via the Transformer-based cross-attention mechanism:

$${E}_{RGB - L} = Attn ( {E}_{RGB} , {E}_{L} ) , {E}_{RGB - L} = Attn ( {E}_{Depth} , {E}_{L} ) \qquad ( 7 )$$

where Attn represents the Transformer-based cross-attention mechanism, through which an RGB-language multimodal feature E_{RGB-L} and a depth-language multimodal feature E_{RGB-L} can be obtained, respectively. Finally, these multimodal features are concatenated (concat) together and input into the Llama2 large language model to predict the next navigation action of the robot.

In the embodiment of the present invention, by taking a robot navigation video (historical video information and current frame video information) and a subtask natural language instruction as input to the Llama2 large language model, an underlying execution command of the robot can be directly output.

Specifically, based on processing of the robot navigation video by the image encoder, in order to enable the model to still understand data in common modalities, special tokens are used to identify different types of information, such as historical information ([HIS] and [/HIS]), a current frame ([OBS] and [/OBS]), and an instruction [NAV]. These identifiers can help the large model distinguish which modality a currently input token sequence comes from, enabling joint training of a plurality of modalities. This joint training method can avoid the problem of catastrophic forgetting, maintaining the understanding of the natural world while learning navigation data.

First, considering the difficulty, high cost, and limited diversity in collecting real data, visual-language navigation data is therefore collected in a Habitat simulator: given an instruction, collect an image sequence in a navigation trajectory corresponding to this instruction and output a corresponding next action; or given an image of a trajectory, output a corresponding instruction. Specifically, semantic segmentation is first performed in the Habitat simulation simulator, and an A* path planning algorithm is used to find the shortest path from a starting point to a target point. Based on semantic information on a path, GPT3.5 is adopted to perform natural language labeling on the navigation trajectory to obtain a video-language data pair.

Then, the collected robot vision-language navigation trajectories are fed into the vision-language large model for training, where the DINOv2 and SigLIP visual encoders, BERT language model, and Llama2 large language model are all pre-trained, and fine-tuning is performed on this basis instead of training from scratch. Continuous measurement ranges of robot navigation actions (moving forward, turning) are discretized into 256-dimensional action tokens, respectively, covering the 256 least-used tokens in a Llama vocabulary. The vision-language large model is trained using a standard next-token prediction target, and only cross-entropy loss on a predicted action token is evaluated. Regarding a “stop” action in robot navigation, it can be directly represented by a single token (0 indicates not stopping, and 1 indicates stopping).

Finally, 50-100 robot vision-language navigation trajectories are collected according to different task scenarios, and LoRA is used to fine-tune the vision-language large model. Then, the vision-language large model can be utilized to fuse multimodal information, parse environment and task requirements, and generate a next navigation action. The robot performs motion control according to a generated navigation instruction and feeds back an execution state simultaneously.

Step S104. A system monitors task progress and an environmental change in real time, and if a new task or an environmental change is detected, it will prompt an operator to perform task adjustment and exception handling, including:

First, through a sensor network and visual perception module, the system continuously collects a current state of the robot (such as a position, a battery level, a task completion degree) and environmental information (such as an obstacle, a dynamic change, etc.), displays it in real time, dynamically updates task and environmental states on a user interface, and intuitively presents the position and the environmental change of the robot;

Then, the system has a built-in exception detection module. When an abnormal situation such as a new obstacle in an environment, a change in a target position, or a sudden task requirement is detected, the system will send a reminder to the operator in the form of sound, an image, and text, prompting the operator to perform task adjustment and exception handling;

Finally, the operator intervenes through a system interface to adjust a task target and a priority, or re-plan a path. The system supports natural language input and a click operation to ensure a fast and efficient adjustment process. Modifications of the operator are synchronized to the robot system in real time, updating task allocation and a navigation strategy to avoid execution interruption.

Specifically, these robots in indoor scenes can transmit their current observations to an upper computer via WiFi wireless communication technology. The upper computer, which is a human-machine interface developed using an MFC application framework, can display observation data of each robot (such as a first-person visual image, a battery level, any load, etc.) and current task execution progress in real time. The robot can detect a newly added obstacle, a dynamic target, or a path blockage in the environment. If a delay, a failure, or other abnormal situations occur in the task, the system will issue a warning prompt, feed back environmental change information or a task abnormal situation to the operator through the interface or voice, and the operator can intervene by inputting a new instruction or adjusting an existing task plan.

Step S105. If a change occurs, the robot dynamically adjusts an execution strategy according to feedback information from the operator and updates a state, including the following: If the system detects a task or environmental change, it will synchronize a new task target to the affected robots, and these robots will dynamically adjust strategies according to the feedback information from the operator. For example, the robot can re-plan a path, adjust a task priority, or reallocate a task to other robots. During execution, the robot updates the state based on the feedback information and continues to perform a new navigation action.

Specifically, the robot vision-language navigation large model receives the feedback information from the operator (such as reallocating a task target, adjusting a path), parses it through the large language model, and generates a new task strategy. According to the new task strategy, the robot adjusts execution logic, such as re-planning a navigation path and modifying a task priority. During execution of an adjusted task, the robot updates its status in real time, including a position, a battery level, a task completion degree, etc. The system synchronously updates the task states and semantic maps of all robots to ensure collaborative consistency among multiple robots.

### Embodiment 2

This embodiment further relates to a vision-language large model-based multi-robot task allocation and collaborative navigation method. It introduces a new large language model-based multi-robot task allocation method, which can allocate the most suitable subtasks according to the different states of each robot. Meanwhile, the present invention introduces a new vision-language multimodality-based robot navigation large model as the action decision-making strategy, which can be generalized to different robot navigation scenarios through fine-tuning with a small amount of data. At the same time, the present invention incorporates a human-robot task collaborative decision-making mechanism and a dynamic task adjustment mechanism, aiming to further improve the execution flexibility and task completion efficiency of the robot system in complex environments. This embodiment is applicable to more complex multi-robot collaboration scenarios, such as disaster rescue, industrial production, and logistics distribution, further expanding the application scope and practical application value of the present invention.

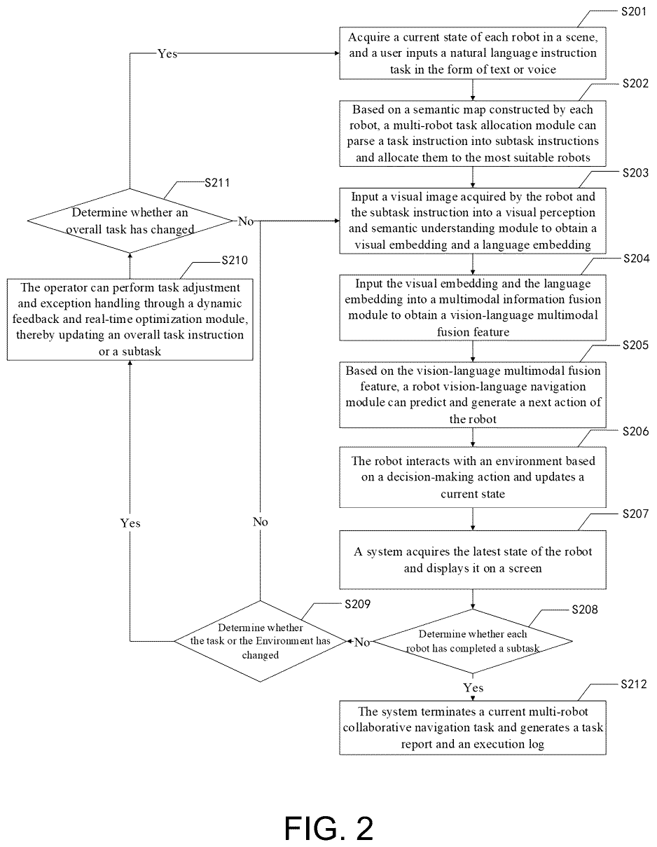

FIG. 2 is a flow chart of another vision-language large model-based multi-robot task allocation and collaborative navigation method provided by an embodiment of the present invention. As shown in FIG. 2, the method specifically includes the following steps:

Step S201: Acquire a current state of each robot in a scene, and a user inputs a natural language instruction task in the form of text or voice.

Step S202: Based on a semantic map constructed by each robot, a multi-robot task allocation module can parse a task instruction into subtask instructions and allocate them to the most suitable robots.

Step S203: Input a visual image acquired by the robot and the subtask instruction into a visual perception and semantic understanding module to obtain a visual embedding and a language embedding.

Step S204: Input the visual embedding and the language embedding into a multimodal information fusion module to obtain a vision-language multimodal fusion feature.

Step S205: Based on the vision-language multimodal fusion feature, a robot vision-language navigation module can predict and generate a next action of the robot.

Step S206: The robot interacts with an environment based on a decision-making action and updates a current state.

Step S207: A system acquires the latest state of the robot and displays it on a screen.

Step S208: Determine whether each robot has completed a subtask, and if not completed, execute Step S209; and if completed, execute Step S212.

Step S209: Determine whether the task or the environment has changed, and if unchanged, jump to Step S203 for iterative operation; and if changed, execute Step S210.

Step S210: The operator can perform task adjustment and exception handling through a dynamic feedback and real-time optimization module, thereby updating an overall task instruction or a subtask.

Step S211: Determine whether the overall task has changed, and if changed, jump to Step S201 for iterative operation; and if not changed, jump to Step S203 for iterative operation.

Step S212: The system terminates a current multi-robot collaborative navigation task and generates a task report and an execution log.

### Embodiment 3

This embodiment further relates to a vision-language large model-based multi-robot task allocation and collaborative navigation system, which is applied to a multi-robot collaborative navigation task with dynamic task allocation.

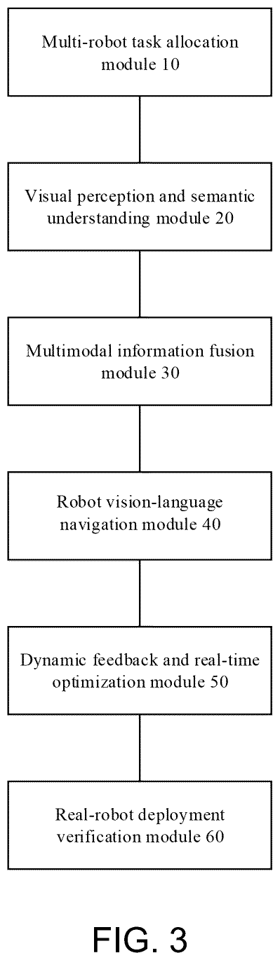

As shown in FIG. 3, the system includes a multi-robot task allocation module 10, a visual perception and semantic understanding module 20, a multimodal information fusion module 30, a robot vision-language navigation module 40, a dynamic feedback and real-time optimization module 50, and a real-robot deployment verification module 60.

The multi-robot task allocation module 10 is configured to parse a high-level task instruction input by a user based on vision-language multimodal representation information, analyze the task instruction through a large language model and decompose it into a plurality of subtasks, and allocate subtask instructions to the most suitable robots.

Specifically, the visual perception and semantic understanding module 20 is configured to perform visual perception and semantic understanding on multimodal input data based on environmental information collected by a robot, including an RGBD visual image and a natural language instruction corresponding to a subtask, and extract key feature information.

The multimodal information fusion module 30 is configured to perform fusion and alignment based on a visual feature and a language feature and generate a unified multimodal representation, with a main purpose of performing unified encoding and representation of input heterogeneous data, enabling information from different modalities to complement and enhance each other.

The robot vision-language navigation module 40 is configured to perform parsing based on fused vision-language multimodal representation information through a large language model (robot vision-language navigation large model) dedicated to each robot, and predict and generate a navigation action of each robot, with the robot executing the action and updating a state.

The dynamic feedback and real-time optimization module 50 is configured to monitor a robot state and task progress in real time based on a state of each robot, and when a new task or an environmental change is detected, prompt the operator to perform task adjustment and exception handling, with the robot dynamically adjusting an execution strategy according to feedback information from the operator and updating the state.

The real-robot deployment verification module 60 is configured to verify and optimize performance of a multi-robot system in an actual working environment based on a developed multi-robot task allocation and collaborative navigation method, ensuring the feasibility, robustness, and efficiency of the vision-language large model-based multi-robot task allocation and collaborative navigation method in practical application scenarios, and providing a reliable basis for further industrial deployment and promotion.

### Embodiment 4

This embodiment further relates to a vision-language large model-based multi-robot task allocation and collaborative navigation system. It introduces a new large language model-based multi-robot task allocation method, which can allocate the most suitable subtasks according to the different states of each robot. Meanwhile, the present invention introduces a new vision-language multimodality-based robot navigation large model as the action decision-making strategy, which can be generalized to different robot navigation scenarios through fine-tuning with a small amount of data. At the same time, the present invention incorporates a human-robot task collaborative decision-making mechanism and a dynamic task adjustment mechanism, aiming to further improve the execution flexibility and task completion efficiency of the robot system in complex environments. This embodiment is applicable to more complex multi-robot collaboration scenarios, such as disaster rescue, industrial production, and logistics distribution, further expanding the application scope and practical application value of the present invention.

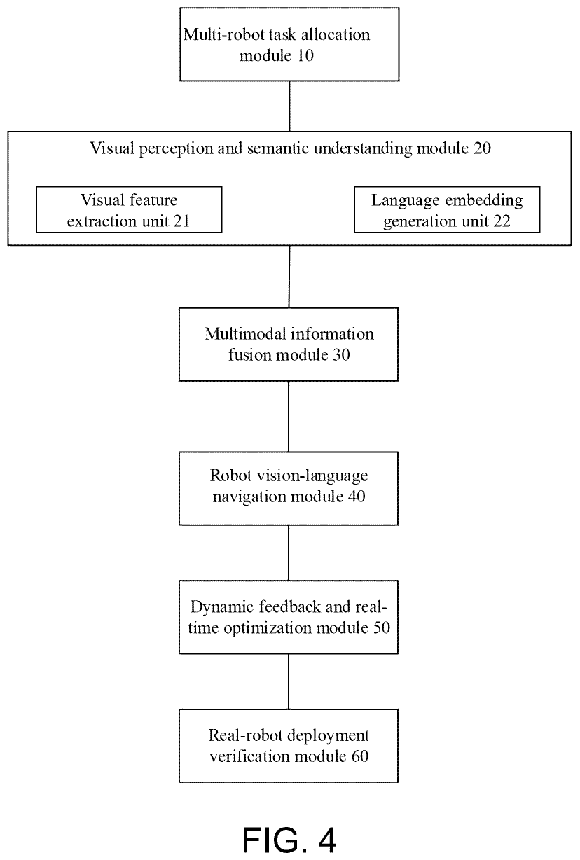

Optionally, FIG. 4 is a schematic diagram of another vision-language large model-based multi-robot task allocation and collaborative navigation system provided by an embodiment of the present invention. As shown in FIG. 4, the visual perception and semantic understanding module 20 includes a visual feature extraction unit 21 and a language embedding generation unit 22.

Specifically, the visual feature extraction unit 21 is configured to extract an RGB visual feature through DINOv2 and SigLIP and extract a depth visual feature through an InceptionNet network based on the RGBD visual image collected by the robot. These high-dimensional visual features can be used for subsequent navigation and task decision-making.

The language embedding generation unit 22 is configured to perform semantic parsing and representation of the task instruction using a pre-trained language model BERT based on the task instruction input by the user and the subtask instruction parsed and decomposed by GPT3.5, and generate language embedding information with high semantic consistency capable of being recognized by the model.

The electronic device of the present invention includes a central processing unit (CPU) that can execute various appropriate actions and processes according to the computer program instructions stored in a read-only memory (ROM) or loaded from a storage unit into a random access memory (RAM). In the RAM, various programs and data required for device operation can also be stored. The CPU, the ROM, and the RAM are connected to each other via a bus. An input/output (I/O) interface is also connected to the bus.

A plurality of components in the device are connected to the I/O interface, including: input units, such as a keyboard and a mouse; output units, such as various types of displays and speakers; storage units, such as a disk and an optical disc; and communication units, such as a network card, a modem and a wireless communication transceiver. The communication unit allows the device to exchange information/data with other devices through a computer network such as the Internet and/or various telecommunication networks.

The processing unit executes each method and process described above, such as methods S101 to S105 and S201 to S210. For example, in some embodiments, the methods S101 to S105 and S201 to S210 may be implemented as computer software programs, which are tangibly embodied in a machine-readable medium, such as a storage unit. In some embodiments, part or all of the computer program may be loaded and/or installed on the device via the ROM and/or the communication unit. When the computer program is loaded into the RAM and executed by the CPU, one or more steps of the methods S101 to S105 and S201 to S212 described above may be executed. Alternatively, in other embodiments, the CPU may be configured to execute methods S101 to S105 and S201 to S212 in any other appropriate manner (for example, by means of firmware).

The functions described above herein can be executed, at least in part, by one or more hardware logic components. For example, without limitation, demonstration types of hardware logic components that can be used include: a field programmable gate array (FPGA), an application-specific integrated circuit (ASIC), an application-specific standard product (ASSP), a system-on-chip (SOC), a complex programmable logic device (CPLD), and so on.

Program codes for implementing the method of the present invention can be written in any combination of one or more programming languages. These program codes can be provided to the processor or controller of a general-purpose computer, a special-purpose computer or other programmable data processing apparatuses, so that the program codes, when executed by the processor or controller, cause the functions/operations specified in the flowcharts and/or block diagrams to be implemented. The program codes can be executed entirely on a machine, partially on a machine, partially on a machine and partially on a remote machine as a standalone software package, or entirely on a remote machine or server.

In the context of the present invention, the machine-readable medium may be a tangible medium that may contain or store a program for use by or in conjunction with an instruction executing system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer disk, a hard disk, a random access memory (RAM), a read-only memory (ROM), an erasable programmable ROM (EPROM or flash memory), an optical fiber, a convenient compact disk ROM (CD-ROM), an optical storage device, a magnetic storage device, or any suitable combination of the above.

Compared with the prior art, the present invention has the following beneficial effects:

By introducing a vision-language large model, the present invention achieves deep fusion of visual and linguistic multimodal data, endowing robots with stronger environmental perception and task understanding capabilities. Through the combination of vision and language, collaboration and dynamic task allocation among multiple robots are realized, and real-time monitoring and adjustment can be performed through human-machine interaction. Compared with traditional systems based on a single sensor, robots can fully understand the environment and task requirements through multimodal perception, thereby improving the adaptability of robots to complex environments and achieving high accuracy in navigation and task allocation.

The task allocation module of the present invention can real-time analyze task requirements, dynamically adjust task allocation strategies, and prioritize the completion of key tasks based on real-time environmental information, task priorities, and robot states. Compared with traditional task allocation methods based on static or predefined rules, the present invention realizes intelligent allocation of task resources, avoids resource waste and task conflicts, and effectively improves the timeliness and accuracy of the overall task completion of the system.

The present invention provides a human-machine interaction module based on natural language and a visual interface, and introduces a safety monitoring and dynamic adjustment mechanism. When a robot encounters obstacles, path conflicts, or other emergencies, it can issue real-time alarms and execute emergency strategies. Meanwhile, operators can perform real-time monitoring and operation of robots through voice instructions, text input, or graphical interfaces. Compared with the interaction methods based on fixed instructions or limited feedback in the prior art, the human-machine interaction of the present invention is more intuitive, efficient, and reliable, which can significantly reduce the operation difficulty.

The preferred specific embodiments of the present invention have been described in detail above. It should be understood that those skilled in the art can make numerous modifications and changes according to the concept of the present invention without creative efforts. Therefore, any technical solution that can be obtained by those skilled in the art through logical analysis, reasoning or limited experiments on the basis of the prior art according to the concept of the present invention shall fall within the scope of protection determined by the claims.

What is claimed is:

1. A vision-language large model-based multi-robot collaborative navigation method, comprising steps of:
according to a task instruction input by a user, combined with a semantic map constructed by each robot, allocating subtask instructions to robots after parsing by a large language model;
collecting, by each robot, an environmental image in real time and mapping it into a visual embedding using a visual perception module, while mapping the allocated subtask language instruction into a language embedding;
performing cross-modal feature alignment on the visual embedding and the language embedding to obtain a vision-language multimodal fusion feature, inputting into a vision-language navigation large model dedicated to each robot for parsing, predicting and generating a navigation action of each robot, and executing, by the robot, the navigation action;
monitoring task progress and an environmental change in real time, and if a new task or an environmental change is detected, performing, by an operator, task adjustment and exception handling; and if the task instruction changes, dynamically adjusting an execution strategy according to feedback information from the operator and updating a state by the robot; and
repeating the above steps until each robot successfully completes the allocated subtask and reaches a target position.

2. The vision-language large model-based multi-robot collaborative navigation method according to claim 1, wherein steps for constructing the semantic map by each robot are specifically as follows:
at an initial state moment, the robot rotating and collecting an RGB image and a depth map in real time through a camera;
for the RGB image, extracting an RGB feature from the RGB image through a pre-trained visual feature extraction network, for the depth map, extracting a depth feature from the depth map through point cloud generation, and jointly modeling the RGB feature and the depth feature through point cloud projection to form an RGB-D joint feature;
based on the RGB-D joint feature, performing layer-by-layer upsampling on the RGB-D joint feature using a decoder of a pre-trained semantic segmentation network, classifying each pixel of the RGB-D joint feature, and generating a semantic segmentation map;
performing three-dimensional point cloud conversion on a pixel-classified label map and depth map, fusing semantic point clouds from a plurality of frames, and mapping to generate a three-dimensional scene model with a semantic label; and
projecting the three-dimensional scene model with the semantic label onto a two-dimensional grid map through two-dimensional grid projection processing to obtain the semantic map.

3. The vision-language large model-based multi-robot collaborative navigation method according to claim 1, wherein steps for allocating the subtask instructions to the most suitable robots after parsing the task instruction input by the user through the large language model are specifically as follows:
adopting a large language model GPT3.5 to replace a scene prior, merging scattered semantic maps according to positions of the robots to obtain a complete pieced semantic map, which comprises information on a robot position, a scene structure, a scene object, and a target category, and formatting them into prompts in a fixed format; and
based on the prompts and a current state of each robot, decomposing an overall task into the most suitable subtasks for each robot, with the large language model GPT3.5 acting as a global planner according to the task instruction input by the user.

4. The vision-language large model-based multi-robot collaborative navigation method according to claim 1, wherein mapping, by the robot, the environmental image collected in real time into the visual embedding using the visual perception module comprises:
extracting an RGB visual embedding using visual encoders with DINOv2 and SigLIP pre-trained features; and
extracting a depth visual embedding using an InceptionNet network; and
mapping the allocated subtask language instruction into the language embedding is specifically as follows: converting the task instruction into a corresponding global vector word embedding, and extracting the language embedding using a pre-trained BERT language model.

5. The vision-language large model-based multi-robot collaborative navigation method according to claim 4, wherein steps for constructing the vision-language multimodal fusion feature are as follows: performing cross-modal feature alignment on the RGB visual embedding and the depth visual embedding in the visual embedding with the language embedding, respectively, using a cross-attention mechanism to obtain an RGB-language multimodal feature E_{RGB-L} and a depth-language multimodal feature E_{RGB-L}; and concatenating the RGB-language multimodal feature and the depth-language multimodal feature and inputting them into a Llama2 large language model to predict a next navigation action of the robot.

6. The vision-language large model-based multi-robot collaborative navigation method according to claim 1, wherein the vision-language navigation large model is based on a Llama2 large language model and adopts joint training of a plurality of modalities, with a training process specifically as follows:
inputting historical video information and current frame video information of a robot navigation video as well as a subtask natural language instruction into the Llama2 large language model;
based on processing of the robot navigation video by an image encoder, identifying different information using special tokens to distinguish which modality a current input token sequence comes from;
feeding collected robot vision-language navigation data into a robot vision-language navigation large model for training: discretizing a continuous measurement range of robot navigation actions into multi-dimensional action tokens, respectively, and covering tokens used in a Llama vocabulary; and training the vision-language large model using a standard next-token prediction target, and evaluating cross-entropy loss on a predicted action token; and
collecting robot vision-language navigation trajectories according to different task scenarios, and fine-tuning the robot vision-language navigation large model using LoRA.

7. The vision-language large model-based multi-robot collaborative navigation method according to claim 6, wherein the vision-language navigation data is collected in a Habitat simulator, specifically as follows:
performing semantic segmentation in the Habitat simulation simulator, finding the shortest path from a starting point to a target point using a path planning algorithm, and performing natural language labeling on a navigation trajectory using GPT3.5 according to semantic information on a path to obtain a video-language data pair; and
given an instruction, collecting an image sequence in a navigation trajectory corresponding to this instruction and outputting a corresponding next action; or given an image of a trajectory, outputting a corresponding instruction.

8. The vision-language large model-based multi-robot collaborative navigation method according to claim 1, wherein the monitoring task progress and an environmental change in real time, and if a new task or an environmental change is detected, performing, by an operator, task adjustment and exception handling are specifically as follows:
detecting, by the robot, a current state and environmental information, and transmitting current observation to an upper computer, wherein the upper computer displays observation data and current task execution progress of each robot in real time;
when an abnormal situation comprising a new obstacle in an environment, a change in a target position, a delay, a failure, or a sudden task requirement is detected, issuing a warning prompt and feeding back environmental change information and a task abnormal situation to the operator, intervening, by the operator, through inputting a new instruction or adjusting an existing task plan, and synchronizing a modification of the operator to a robot system in real time; and
receiving, by the robot vision-language navigation large model, feedback information of the operator, parsing it through the large language model and generating a new task strategy, adjusting, by the robot, execution logic according to the new task strategy, and updating its own state in real time during execution of an adjusted task; and synchronously updating, by the system, task states and semantic maps of all robots.

9. A vision-language large model-based multi-robot collaborative navigation system adopting the vision-language large model-based multi-robot collaborative navigation method according to claim 1, comprising:
a multi-robot task allocation module configured to parse a high-level task instruction input by the user based on vision-language multimodal representation information, analyze the task instruction through the large language model and decompose it into a plurality of subtasks, and allocate subtask instructions to the most suitable robots;
a visual perception and semantic understanding module configured to perform visual perception and semantic understanding on multimodal input data based on environmental information collected by a robot, comprising an RGBD visual image and a natural language instruction corresponding to a subtask, and extract key feature information;
a multimodal information fusion module configured to perform fusion and alignment based on a visual feature and a language feature, generate a unified multimodal representation, and perform unified encoding and representation of input heterogeneous data;
a robot vision-language navigation module configured to perform parsing based on fused vision-language multimodal representation information through a dedicated robot vision-language navigation large model of each robot, and predict and generate the navigation action of each robot, with the robot executing the action and updating a state;
a dynamic feedback and real-time optimization module configured to monitor a robot state and task progress in real time based on a state of each robot, and when a new task or an environmental change is detected, prompt the operator to perform task adjustment and exception handling, with the robot dynamically adjusting an execution strategy according to feedback information from the operator and updating the state; and
a real-robot deployment verification module configured to verify and optimize performance of a multi-robot system in an actual working environment based on a developed multi-robot collaborative navigation method.

10. The vision-language large model-based multi-robot collaborative navigation system according to claim 9, wherein the visual perception and semantic understanding module comprises:
a visual feature extraction unit configured to extract an RGB visual feature through DINOv2 and SigLIP and extract a depth visual feature through an InceptionNet network based on the RGBD visual image collected by the robot for subsequent navigation and task decision-making; and
a language embedding generation unit configured to perform semantic parsing and representation of the task instruction using a pre-trained language model BERT based on the task instruction input by the user and the subtask instruction parsed and decomposed by GPT3.5, and generate language embedding information with high semantic consistency capable of being recognized by the model.
